(19) United States
(12) Patent Application Publication
(10) Pub. No.: US 2016/0291680 A1
(43) Pub. Date: Oct. 6, 2016

(54) POWER MONITOR FOR AN ELECTRONIC DEVICE

(71) Applicant: INTEL CORPORATION, Santa Clara, CA (US)

(72) Inventors: Ruoying Mary MA, Portland, OR (US); James G. HERMERDING II, Vancouver, WA (US); Efraim ROTEM, Haifa (IL); Jorge P. RODRIGUEZ, Portland, OR (US); Jeffrey A. CARLSON, Portland, OR (US)

(21) Appl. No.: 15/037,423

(22) PCT Filed: Dec. 27, 2013
(86) PCT No.: PCT/US2013/078121

§ 371 Date: May 18, 2016

(51) Int. Cl. G06F 1/32

(52) U.S. Cl. CPC G06F 1/3262; G06F 1/3293; G06F 1/3212; G06F 1/3253

(57) ABSTRACT

An electronic device comprising: a power monitor to receive system power to be delivered to a processor and to one or more components of a system, the power monitor to provide information corresponding to the system power, and a processor to change a performance of the processor based at least in part on the information corresponding to the system power.

### BACKGROUND

1. Field

Embodiments may relate to a power monitor to provide performance information, such as total system power information.

2. Background

As integrated circuit (IC) fabrication technology improves, manufacturers may integrate additional functionality onto a single silicon substrate. As the number of these functionalities increases, so does a number of components on a single IC chip. Additional components may add additional signal switching, which may generate more heat. The additional heat may damage an IC chip by thermal expansion, for example. The additional heat may also limit usage locations and/or usage applications of an electronic device that includes such chips.

For example, an electronic device (e.g. a portable computing device) may rely solely on battery power for its operations. As additional functionality is integrated into the electronic devices, a need to reduce power consumption may become more important to maintain battery power for an extended period of time, for example.

### BRIEF DESCRIPTION OF THE DRAWINGS

Arrangements and embodiments may be described in detail with reference to the following drawings in which like reference numerals refer to like elements and wherein:

FIG. 1 is a block diagram of an electronic system according to an example arrangement;

FIG. 2 is a block diagram of an electronic system according to an example arrangement;

FIG. 3 shows power monitor system according to an example embodiment;

FIG. 4 shows a power monitor system of an electronic device according to an example embodiment;

FIG. 5 shows a power monitor system of an electronic device according to an example embodiment

FIG. 6 shows a power monitor system of an electronic device according to an example embodiment;

FIG. 7 shows a power monitor system of an electronic device according to an example embodiment;

FIGS. 8A-8B show a power monitor system according to an example embodiment; and

FIGS. 9A-9B show a power monitor system according to an example embodiment.

### DETAILED DESCRIPTION

In the following description, numerous specific details are set forth in order to provide a thorough understanding of various arrangements and embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), and/or some combination of hardware and software. For ease of description reference to “logic” shall mean either hardware, software, or some combination thereof.

A power delivery network may be a limitation to computational performance in general and turbo performance in particular. There are different hierarchies of the power delivery network that might limit a total power consumption (or total system power consumption). The problem may be solved by controlling the CPU (Central Processing Unit) power only and assigning a fixed budget to a remainder of a platform with guard band. This may result in non-optimal settings or risk of shut down when the guard band is not sufficient.

An arrangement and/or at least one embodiment may target a total platform power consumption (or total system power consumption) based on various information, e.g., including one or more inputs/readings obtained from the platform components, control value (or parameter) setting, and control policy. This approach may be supplemented, e.g., by using remote sensing of platform power. For example, an (e.g., electrical current) sensor on the platform may sample a current consumption and provide this information to the CPU VR from which it is being sampled and controlled.

Providing control of the total platform power consumption (or total system power consumption) may permit usage of a smaller power supply unit(s), less design guard band, and/or a more robust system with a reduced risk for system shut down. This may be important for small form factors such as tablets, phones, and ultrabooks, as well as servers.

Arrangements and embodiments may be applied in systems that include one or more processors (e.g., with one or more processor cores).

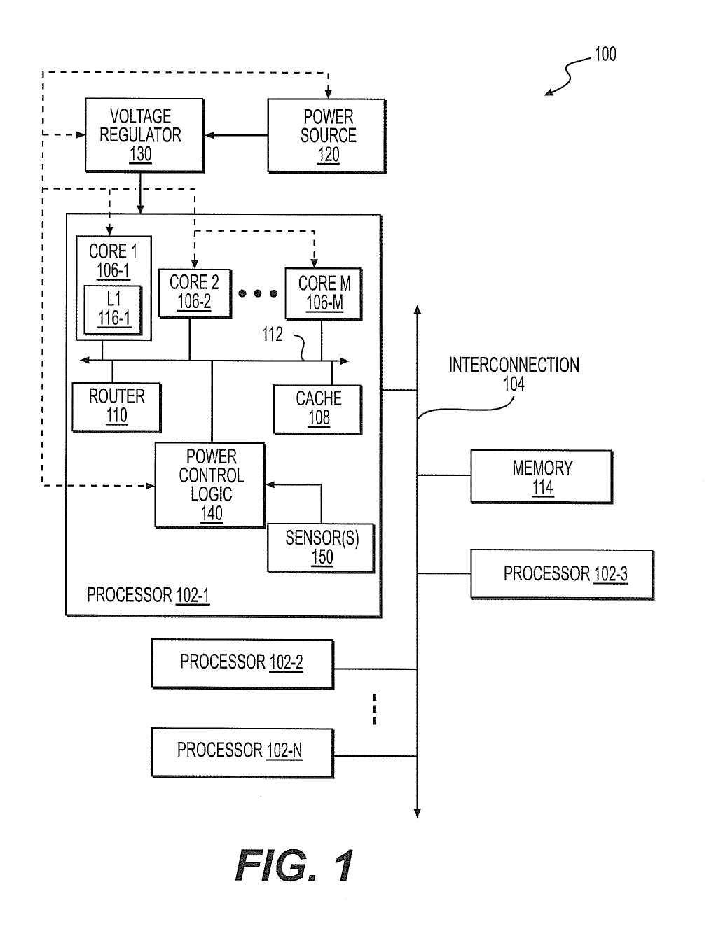

FIG. 1 illustrates a block diagram of an electronic system 100 (or computing system) according to an example arrangement. Other arrangements may also be provided.

The electronic system 100 may include one or more processors 102-1 through 102-N (herein referred to as the processors 102 or the processor 102). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

The processor 102-1 may include one or more processor cores 106-1 through 106-M (hereinafter referred to as cores 106 or core 106), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers, or other components.

The router 110 may be used to communicate between various components of the processor 102-1 and/or the system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. The cache 108 (that may be shared) may be a mid-level cache (MLC), a last level cache (LLC), etc. Also, each of the cores 106 may include a level 1 (L1) cache (116-1) (also referred to as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

The system 100 may also include a power source 120 (e.g., a direct current (DC) power source or an alternating current (AC) power source) to provide power to one or more components of the system 100. The power source 120 may be a platform power source, for example. The platform power source may be a PSU. The power source 120 may include one or more battery packs and/or power supplies. The power source 120 may be coupled to components of the system 100 through a voltage regulator (VR) 130. Moreover, even though FIG. 1 illustrates one power source 120 and one voltage regulator 130, additional power sources and/or voltage regulators may be utilized. For example, one or more of the processors 102 may have corresponding voltage regulator(s) and/or power source(s). The voltage regulator(s) 130 may be coupled to the processor 102 via a single power plane (e.g., supplying power to all the cores 106) or multiple power planes (e.g., where each power plane may supply power to a different core or group of cores).

Additionally, while FIG. 1 shows the power source 120 and the voltage regulator 130 as separate components, the power source 120 and the voltage regulator 130 may be incorporated into other components of the system 100. For example, all or portions of the VR 130 may be incorporated into the power source 120 and/or the processor 102.

As shown in FIG. 1, the processor 102 may further include a power control logic 140 to control supply of power to components of the processor 102 (e.g., cores 106). The logic 140 may have access to one or more storage devices discussed herein (such as the cache 108, the L1 cache 116, the memory 114, or another memory in the system 100) to store information relating to operations of the logic 140 such as information communicated with various components of the system 100. As shown, the logic 140 may be coupled to the VR 130 and/or other components of the system 100 such as the cores 106 and/or the power source 120.

For example, the logic 140 may be coupled to receive information (e.g., in the form of one or more bits or signals) to indicate status of one or more sensors 150. The sensor(s) 150 may be provided proximate to component(s) of the system 100, such as the cores 106, interconnections 104 or 112, components outside of the processor 102, etc., to sense variations in various factors affecting power/thermal behavior of the system/platform, such as temperature, operating frequency, operating current, operating voltage, power consumption, and/or inter-core communication activity, etc.

The logic 140 may instruct the VR 130, the power source 120, and/or individual components of the system 100 (such as the cores 106) to modify their operations. For example, the logic 140 may indicate to the VR 130 and/or the power source 120 (or PSU) to adjust their output. The logic 140 may request the cores 106 to modify their operating frequency, operating current, power consumption, etc. Even though the components 140 and 150 are shown to be included in the processor 102-1, these components may be provided elsewhere in the system 100. For example, the power control logic 140 may be provided in the VR 130, in the power source 120, directly coupled to the interconnection 104, within one or more (or alternatively all) of the processors 102, etc. Furthermore, as shown in FIG. 1, the power source 120 and/or the voltage regulator 130 may communicate with the power control logic 140 and report their power specification.

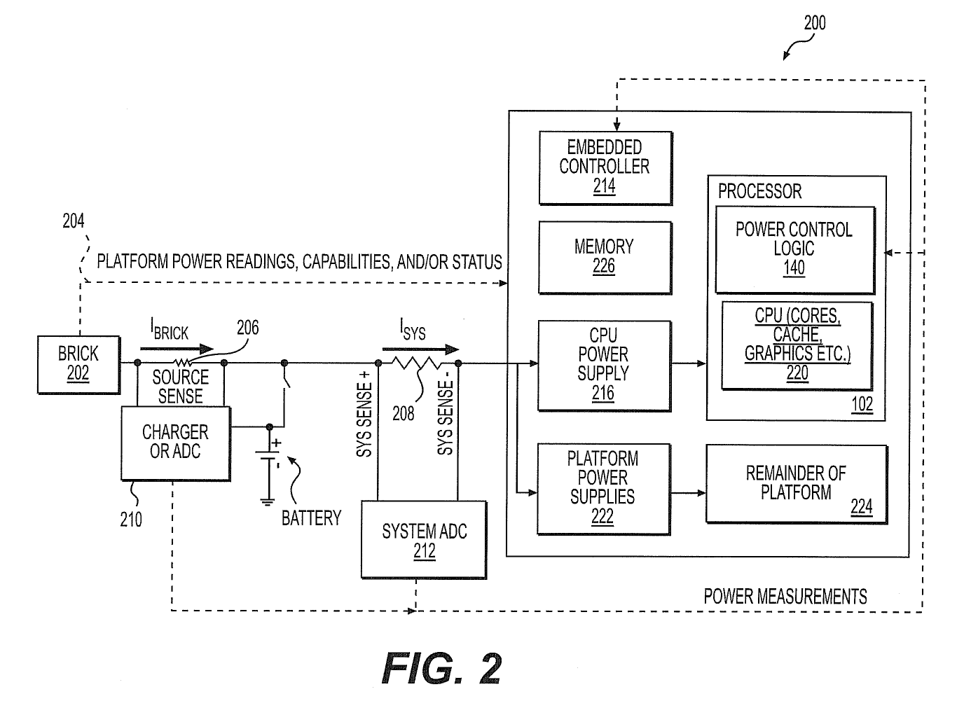

FIG. 2 is a block diagram of an electronic system according to an example embodiment. Other embodiments and configurations may also be provided. The electronic system may include a power management system 200.

Power readings (e.g., power consumption value (e.g., delivered), capabilities, and/or status) may be provided (e.g., digitally) from an intelligent brick 202 via a communication link 204 or sense resistors in series to the brick and/or in series to the total system (brick and battery), resistors 206 and 208, respectively. A brick may generally refer to a power supply (such as the power supply 120 of FIG. 1) that is capable of converting AC (Alternating Current) to DC (Direct Current) that is to be used by an electronic device. Furthermore, an intelligent brick may generally refer to a power supply that is capable of performing other functions (such as those discussed herein) in addition to just power conversion.

FIG. 2 shows a battery charger with internal (integrated) ADC (analog-to-digital converter) 210 to sample voltage across the resistor 206 and provide a digitized signal. FIG. 2 also shows a system ADC 212 to sample a voltage across the resistor 208 and provide a digitized signal. The digitized signal (from the charger or ADC 210 and the system ADC 212) may represent power (i.e., instantaneous platform power) consumed by/delivered to the system.

As shown in FIG. 2, the ADCs 210 and 212 may sample the voltage across the resistors 206 and 208, respectively. The ADC can be dedicated (such as ADCs 212), integrated into an embedded controlled 214, integrated into VR (such as the VR 130 of FIG. 1, within a CPU Power Supply 216), and/or integrated into a chip. Control may be performed by the power control logic 140 (also referred to herein as PMU (Power Management Unit) or PCU (Power Control Unit)), the embedded controller 214.

In FIG. 2, the power management system 200 may divide the contents of the CPU/processor 102 into the control logic 140 and the remaining portions of the processor 220. A platform power supply/supplies 222 may also be included to supply power to the remainder of platform 224 (i.e., other than one or more processors 102, for example). The system 200 may also include a memory. Power measurements (e.g., from items 210 and 212) may also be provided to the logic 140 and/or the embedded controller 214, for example.

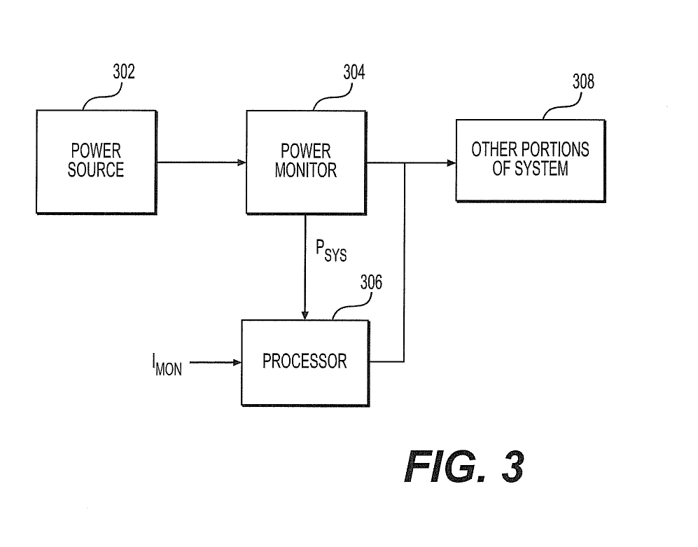

FIG. 3 shows a power monitor system according to an example embodiment. Other embodiments and configurations may also be provided.

The power control discussed with respect to FIG. 3 may provide power to a platform of an electronic device, such as a mobile terminal. The platform may include a display, a processor, a controller, etc.

FIG. 3 shows a power source 302, a power monitor 304, a processor 306 and other portions of system 308 (or platform). The power source 302 may provide power to the power monitor 304. The power received at the power monitor 304 may be provided to other portions of the electronic device, such as a load. In at least one embodiment, the power monitor 304 may be part of the electronic device.

The power monitor may also be referred to as a power meter and/or a power sensor.

The power monitor 304 may provide power information based on the received power from the power source 302 and deliver the information to the other portions of system 308 and the processor 306. In at least one embodiment, the power monitor 304 may provide the power information in an analog manner. In at least one embodiment, the power monitor 304 may provide the power information in a digital manner. The power information that is provided may be a total system power information (or total system power consumption). The power monitor 304 may provide total system power information based on the received power.

The power monitor 304 may provide an instantaneous power value (P_{SYS}) to the processor 306. The instantaneous power value P_{SYS} may be a total system power consumption (or total system power information) as measured or determined at the power monitor 304.

As one example, the power monitor 304 may include part of a charger of the electronic device. As one example, the power monitor 304 may include a dedicated silicon sensor. The power monitor 304 may monitor the total platform power received from the power source 302 (e.g. the power consumed by the other portions of system 308 and the processor 306), and generate an electronic signal (analog or digital format) proportional to the measured instantaneous power. The total system power information may include a total instantaneous power value.

The instantaneous power value (P_{SYS}) may be provided to the processor 306. The processor 306 may change a performance of the processor 306 based on the received power information. The processor 306 may change (or adjust) a performance (or performance parameter) based on the total system power information that is received. In other words, the processor 306 may receive total system power information. This is an improvement over other arrangements in which a processor may change a performance based on a “pseudo” total system power information comprised of the monitored processor 306 power and the fixed platform power offset. In other words, the total system power information that is provided by the power monitor 304 is more accurate than an “assumed” total system power comprised of a fixed platform power value and the monitored processor power.

The processor 306 may also receive a current value I_{MON}. The current value I_{MON} may be used by the processor 306 to determine the processor's power consumption. The current value I_{MON} is an analog signal proportional to an average output current of the voltage regulator that powers the processor 306. The current value I_{MON} is supplied by the voltage regulator 130 (FIG. 1) of the processor 306.

FIG. 3 also shows that the power from the power source 302 may be provided from the power monitor 304 to other portions of system 308, such as a load having a display, for example, and monitored by the power monitor 304. Power may also be provided to the processor 306.

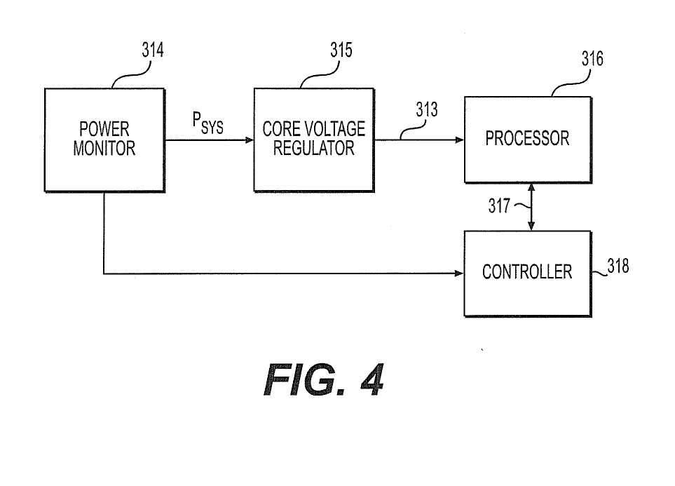

FIG. 4 shows a power monitor system of an electronic device according to an example embodiment. Other embodiments and configurations may also be provided.

The embodiment shown in FIG. 4 is a more detailed embodiment of the FIG. 3 embodiment. Components shown in FIG. 4 may be provided in an electronic device, such as a mobile terminal. Other components of a system (or platform) of the electronic device may also be provided.

The FIG. 4 embodiment may include an analog power monitor and/or methodology of using an analog value of a power value (such as total system power information). In at least one embodiment, the power monitor may include a silicon sensor to sense a total system current. The silicon sensor may provide an analog signal.

FIG. 4 shows a power monitor 315, a core voltage regulator 315 (or processor voltage regulator), a processor 316 and a controller 318. The power monitor 315 may be an analog power monitor. In at least one embodiment, the processor 316 may be a central processing unit (CPU). In at least one embodiment, the controller 318 may be an embedded controller. The embedded controller may be provided within the processor 316, for example.

The power monitor 314 may receive power from a power source, such as the power source 302 (FIG. 3).

The power monitor 314 may provide power information based on the received power. As one example, the power monitor 314 may provide an instantaneous power value P_{SYS} to the core voltage regulator 315 (or processor voltage regulator). The instantaneous power value P_{SYS} may be a total system power consumption (or total system power information) as measured or determined at the power monitor 314.

In at least one embodiment, the power monitor 314 may provide an analog value of the instantaneous power value P_{SYS}. The analog value may be measured or determined by an analog measurement or determination.

The analog value of the instantaneous power value P_{SYS} may be provided to the core voltage regulator 315 (or processor voltage regulator), which provides a constantly monitored/tightly regulated voltage to the processor 316.

The power monitor 314 may receive system power to be delivered to the processor 316 and to one or more components of a system. The power monitor 314 may provide information corresponding to system power.

The core voltage regulator 315 may convert the analog value of the instantaneous power value P_{SYS} into a digital value, and provide the digitized P_{SYS} value to the processor 316. The core voltage regulator 315 may provide the total system power information (in a digitized manner) to the processor 316. The digitized P_{SYS} value may be provided along a bus 313 to the processor 316. In at least one embodiment, the bus 313 may be a SVID bus (utilizing a communication protocol for Serial VID provided by Intel Corporation).

The power monitor 314 may also provide a current value (or a thermal temperature value) to the controller 318. The current value (or the thermal temperature value) may be provided along a communication link that provides two-way communication between the controller 318 and the power monitor 314. In at least one example, this may provide proper scaling of the generated power signal (the power value P_{SYS}) from the power monitor 314 and specific to the platform's maximum power consumption capabilities.

The controller 318 may provide information to the processor 316 across an interface 317, such as a platform environment control interface (PECI) for thermal management.

As shown in FIG. 4, the processor 316 may receive power information from the power monitor 314. The processor 316 (or other device) may change the performance of the processor 316 based on the received power information. The processor 316 may change (or adjust) a performance (or performance parameter) based on the total system power information that is received. In other words, the processor 316 may receive total system power information. The processor 316 may change a performance of the processor 316 based at least in part on the information corresponding to system power. The information corresponding to the system power may include a value corresponding to instantaneous power.

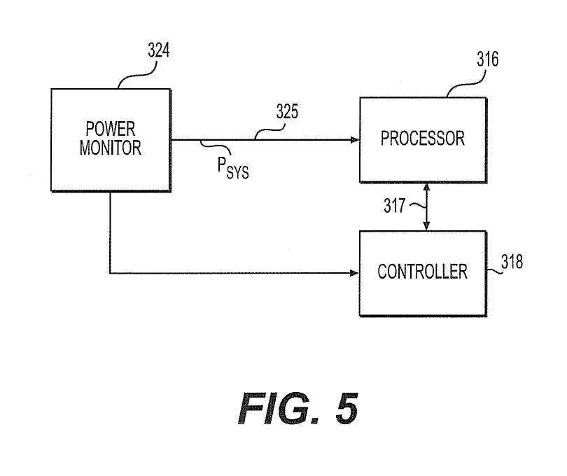

FIG. 5 shows a power monitor system of an electronic device according to an example embodiment. Other embodiments and configurations may also be provided.

The embodiment shown in FIG. 5 is a more detailed embodiment of the FIG. 3 embodiment. Components shown in FIG. 5 may be provided in an electronic device. Other components of a system (or platform) of an electronic device may also be provided.

The FIG. 5 embodiment may include a digital power monitor and/or methodology of using a digital value of a power value (such as total system power information). In at least one embodiment, the power monitor may include a silicon sensor to sense a total system current. The silicon sensor may provide digitized data through a bus to a processor directly. The FIG. 5 embodiment is a digital system. The power monitor 324 may monitor and directly digitize (or quantize) the power signal (the power value P_{SYS}) for immediate transmission to the processor 316 via a digital interface/bus 325, such as a SVID bus interface. This embodiment may not rely on the core voltage regulator 315 (in FIG. 4) or other analog-to-digital conversion means to quantize the power signal (the power value P_{SYS}).

FIG. 5 shows a power monitor 324, the processor 316 and the controller 318. The power monitor 324 may be a digital power monitor, for example. In at least one embodiment, the processor 316 may be a central processing unit (CPU). In at least one embodiment, the controller 318 may be an embedded controller 318. The embedded controller 318 may be provided within the processor 316, for example.

The power monitor 324 may receive power from a power source, such as the power source 302 (FIG. 3).

The power monitor 324 may provide power information based on the received power. As one example, the power monitor 324 may provide an instantaneous power value P_{SYS} directly to the processor 316. The instantaneous power value P_{SYS} may be a total system power consumption (or total system power information) as measured or determined at the power monitor 324.

In at least one embodiment, the power monitor 314 may provide a digital value of the instantaneous power value P_{SYS}. The digital value may be measured or determined by a digital measurement or determination at the power monitor 324.

The digital value of the instantaneous power value P_{SYS} may be directly provided to the processor 316 along a bus 325, such as a SVID bus.

The power monitor 324 may receive system power to be delivered to the processor 316 and to one or more components of a system. The power monitor 324 may provide information corresponding to system power.

The power monitor 324 may also provide a current value to the controller 318. The current value (or thermal temperature value) may be provided along a communication link that provides two-way communication between the platform controller (or system controller) and the power monitor 324. In at least one example, this may provide proper scaling of the generated power signal (the power value P_{SYS}) from the power monitor 324 and specific to the platform's (or system's) maximum power consumption capabilities.

The controller 318 may provide information to the processor 316 across an interface 317, such as a platform environment control interface (PECI) for thermal management.

As shown in FIG. 5, the processor 316 may receive power information from the power monitor 324. The processor 316 (or other device) may change the performance of the processor 316 based on the received power information. The processor 316 may change (or adjust) a performance (or performance parameter) based on the total system power information that is received. In other words, the processor 316 may receive total system power information. The processor 316 may change a performance of the processor 316 based at least in part on the information corresponding to system power. The information corresponding to the system power may include a value corresponding to instantaneous power.

In at least one embodiment, the power monitor 314, 324 may be part of a charger. In at least one embodiment, the power monitor 314, 324 may include a silicon sensor.

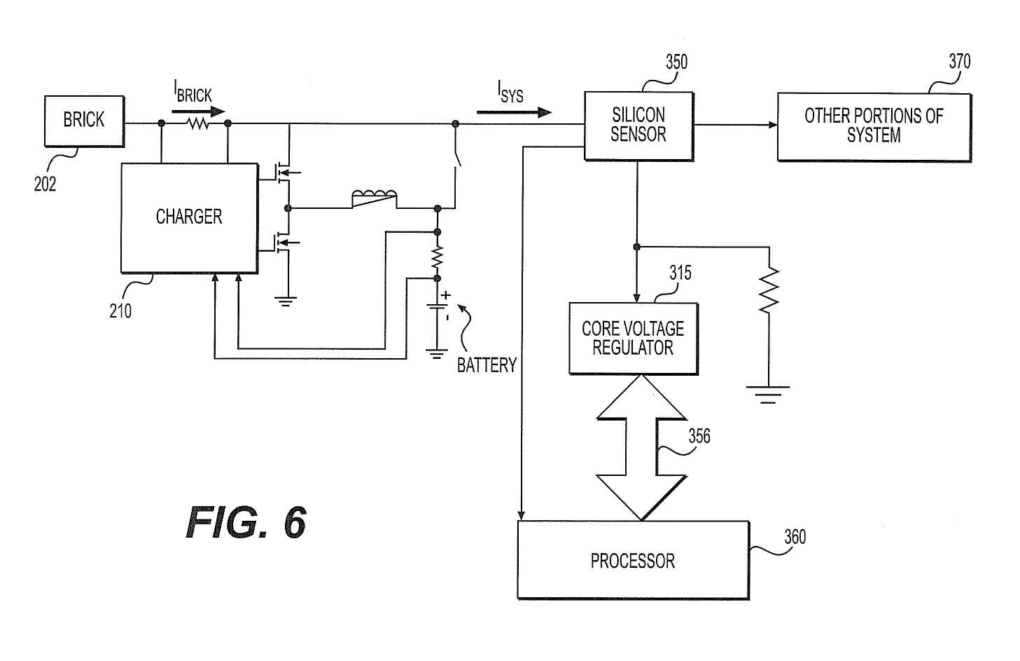

FIG. 6 shows a power monitor system of an electronic device according to an example embodiment. Other embodiments and configurations may also be provided.

The embodiment shown in FIG. 6 is a more detailed embodiment of the FIG. 3 embodiment. The FIG. 6 embodiment includes features of the FIG. 4 embodiment to provide information based on analog data from the power monitor 312. Components shown in FIG. 6 may be provided in an electronic device. Other components of a system (or platform) of the electronic device may also be provided.

The FIG. 6 embodiment may include an analog power monitor and/or methodology of using an analog value of a power value (such as total system power information).

FIG. 6 shows the brick 202 (or AC adapter), the charger 210, a silicon sensor 350, the core voltage regulator 315, a processor 360 and other portions of a system 370.

In at least one embodiment, the silicon sensor 350 may determine or receive power information (such as total system power information or total system current). For example, FIG. 6 shows the silicon sensor 350 to receive or determine power information based on a sensed total current, such as I_{SYS}. The silicon sensor 350 may monitor the instantaneous voltage across its input and output nodes, compute the equivalent power, and generate a signal (voltage or current-mode) proportional to the monitored power. The analog information may be provided to the core voltage regulator 315. The silicon sensor 350 may provide at least a portion of the information corresponding to the system power.

The silicon sensor 350 may sense the total system current I_{SYS} using this information to compute the equivalent total system power. The silicon sensor 350 may provide an analog signal to the core voltage regulator 315.

The core voltage regulator 315 may convert the analog value of the sensed system current I_{SYS} into a digital value, and provide the digitized sensed current to the processor 360 along a bus 356, such as a SVID bus. The core voltage regulator 315 may receive a portion of the total system power information as an analog value, and provide a digitized value of the portion of the total system power information to the processor 316.

The silicon sensor 350 may also provide a current value to the processor 360. As one example, the current value may be provided from the silicon sensor 350 to an embedded controller of the processor 360. In at least one example, a status/control signal may be provided.

The processor 360 may receive power information from the power monitor, which may include the silicon sensor 350. The processor 360 (or other device) may change the performance of the processor 360 based on the received power information. The processor 360 may change (or adjust) a performance (or performance parameter) based on the total system power information that is received (or the total system current). In other words, the processor 360 may receive total system power information.

As shown in FIG. 6, the bus 356 may be provided between the core voltage regulator 315 (or converting device) and the processor 360. The core voltage regulator 315 (or converting device) may provide the digitized value of the portion of the total system power information to the bus 356. The bus 356 may provide the digitized value of the portion of the total system power information to the processor.

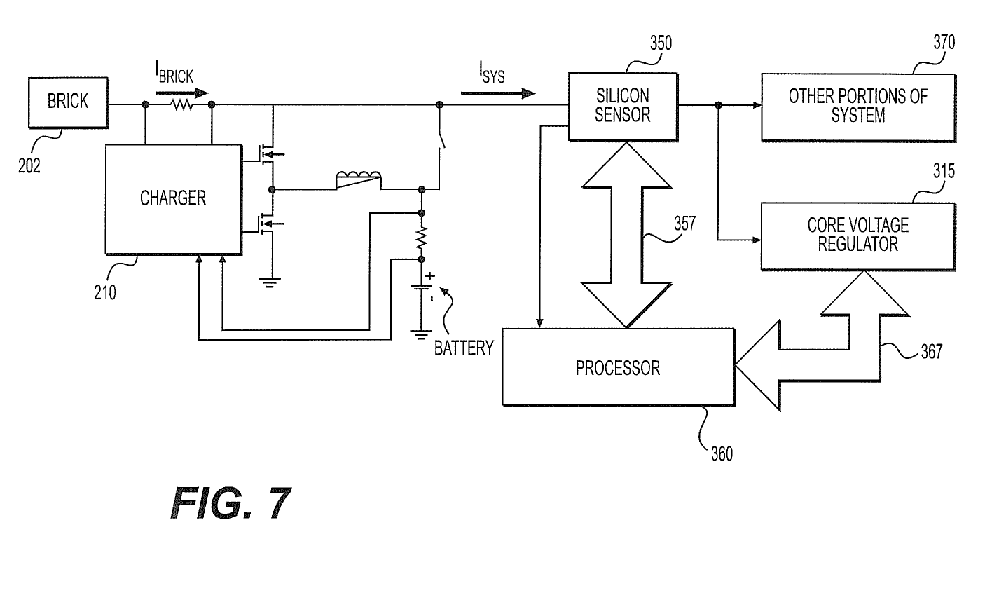

FIG. 7 shows a power monitor system of an electronic device according to an example embodiment. Other embodiments and configurations may also be provided.

The embodiment shown in FIG. 7 is a more detailed embodiment of the FIG. 3 embodiment. The FIG. 7 embodiment includes features of the FIG. 5 embodiment to provide information based on digital data from the power monitor 324. Components shown in FIG. 7 may be provided in an electronic device. Other components of a system (or platform) of the electronic device may also be provided.

The FIG. 7 embodiment may include a digital power monitor and/or methodology of using a digital value of a power value (such as total system power information).

FIG. 7 shows the brick 202, the charger 210, the silicon sensor 350, the processor 360 and other portions of system 370. FIG. 7 also shows the core voltage regulator 315 coupled to the processor 360 via a bus 367, such as a SVID bus.

In at least one embodiment, the silicon sensor 350 may determine or receive power information (such as total system power information or total system current). For example, FIG. 7 shows the silicon sensor 350 to receive or determine power information based on a sensed total current, such as I_{SYS}. The digital information may be directly provided to the processor 360 along a bus 357.

The silicon sensor 350 may sense the total system current I_{SYS}. The silicon sensor 350 may provide a digital signal to the processor 360.

The processor 360 may receive power information from the power monitor, which may include the silicon sensor 350. The processor 360 (or other device) may change the performance of the processor 360 based on the received power information. The processor 360 may change (or adjust) a performance (or performance parameter) based on the total system power information that is received (or the total system current). In other words, the processor 360 may receive total system power information.

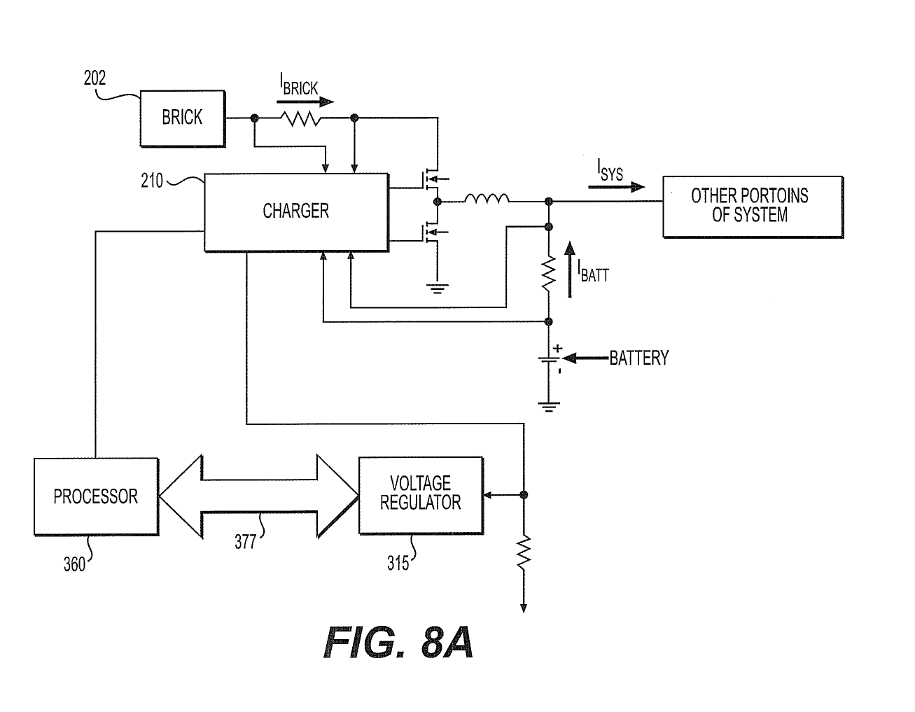

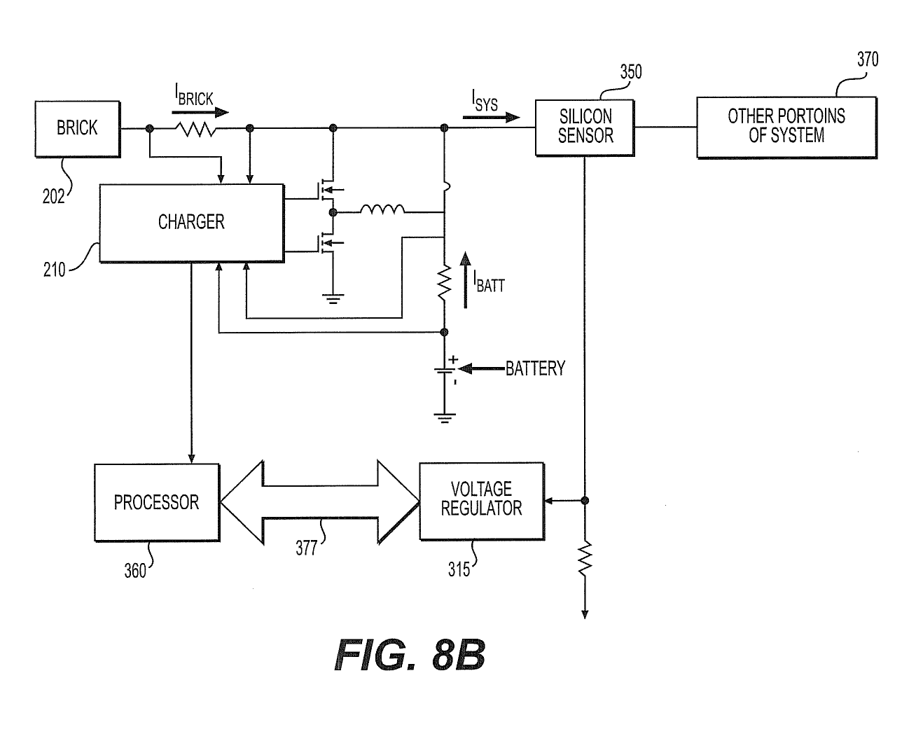

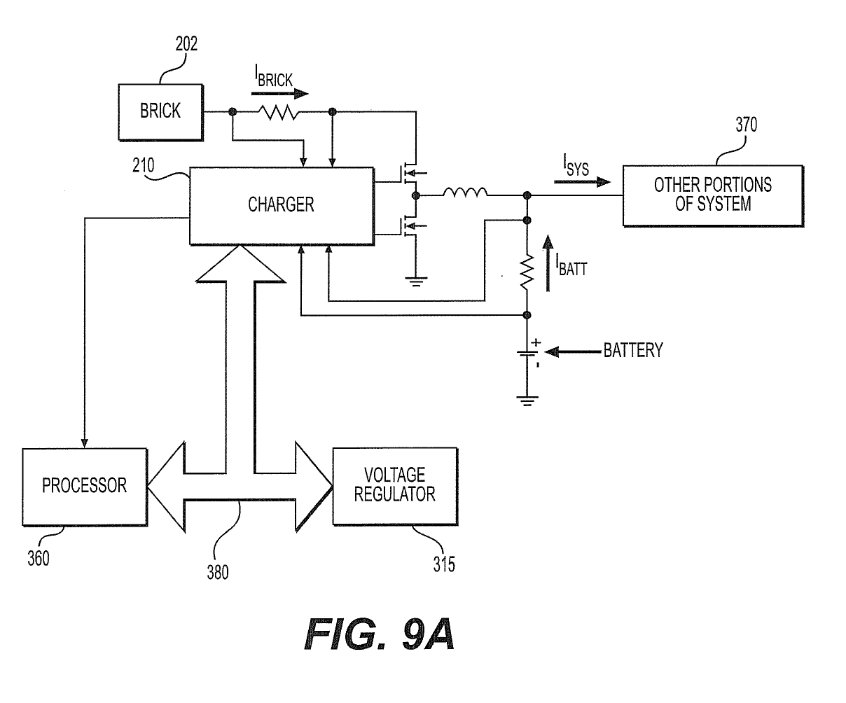

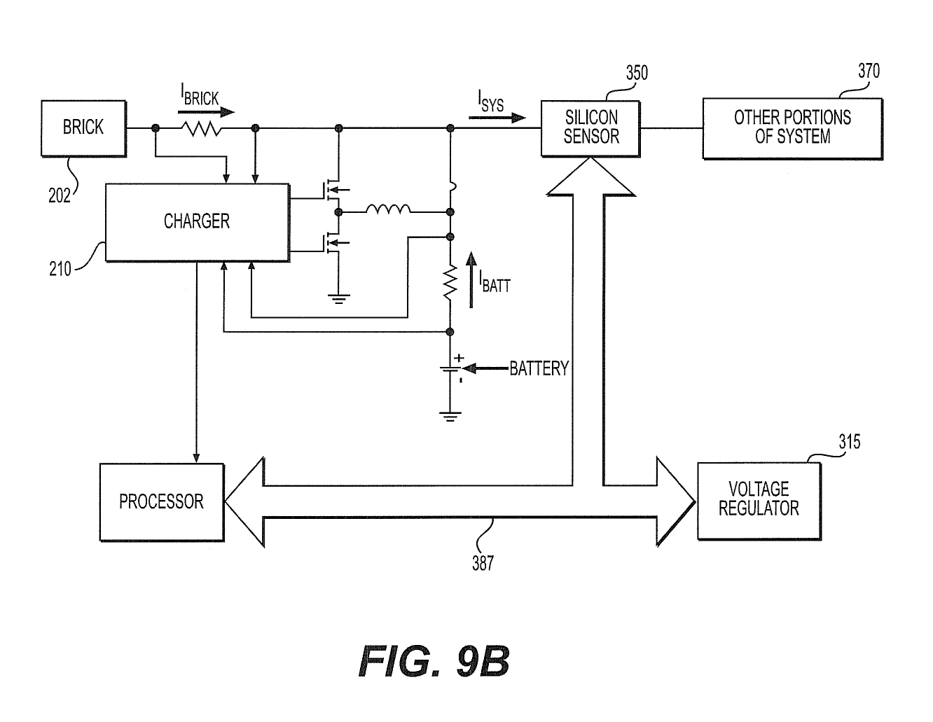

The above-described embodiments of FIGS. 6-7 relate to analog and digital versions of a hybrid power boost power schemes. The hybrid power boost power schemes show a silicon sensor. The following FIGS. 8A-9B relate to a Narrow VDC scheme, and show a silicon sensor.

FIGS. 8A-8B show a power monitor system of an electronic device according to an example embodiment. FIG. 8B shows a silicon sensor used in a narrow VDC scheme. Other embodiments and configurations may also be provided.

The FIG. 8A embodiment may include an analog power monitor and/or methodology of using an analog value of a power value (such as total system power information).

FIG. 8A shows the brick 202, the charger 210, the core voltage regulator 315, the processor 360 and the other portions of system 370. FIG. 8B shows the circuit with the silicon sensor 350.

In at least one embodiment, the silicon sensor 350 may determine or receive power information (such as total system power information or total system current). For example, FIG. 8B shows the silicon sensor 350 to receive or determine power information based on a sensed total current, such as I_{SYS}. The analog information may be provided to the core voltage regulator 315.

The silicon sensor 350 may sense the total system current I_{SYS}. The silicon sensor 350 may provide an analog signal to the core voltage regulator 315.

The core voltage regulator 315 may convert the analog value of the sensed system current I_{SYS} into a digital value, and provide the digitized sensed current to the processor 360 along a bus 377, such as a SVID bus.

The silicon sensor 350 may also provide a current value to the processor 360. As one example, the current value may be provided from the silicon sensor 350 to an embedded controller of the processor 360.

The processor 360 may receive power information from the power monitor, which may include the silicon sensor 350. The processor 360 (or other device) may change the performance of the processor 360 based on the received power information. The processor 360 may change (or adjust) a performance parameter based on the total system power information that is received (or the total system current). In other words, the processor 360 may receive total system power information.

FIGS. 9A-9B show a power monitor system of an electronic device according to an example embodiment. FIG. 9B shows a silicon sensor used in a narrow VDC scheme. Other embodiments and configurations may also be provided.

The FIG. 9A embodiment may include a digital power monitor and/or methodology of using a digital value of a power value (such as total system power information).

FIG. 9A shows the brick 202, the charger 210, the silicon sensor 350, the processor 360 and the other portions of system 370. FIG. 9B shows the circuit with the silicon sensor 350. FIG. 9A also shows the core voltage regulator 315 coupled to the processor 360 via a bus 387, such as a SVID bus.

In at least one embodiment, the silicon sensor 350 may determine or receive power information (such as total system power information or total system current). For example, FIG. 9B shows the silicon sensor 350 to receive or determine power information based on a sensed total current, such as I_{SYS}. The digital information may be provided to the processor 360 along the bus 387.

The silicon sensor 350 may sense the total system current I_{SYS}. The silicon sensor 350 may provide a digital signal to the processor 360.

The processor 360 may receive power information from the power monitor, which may include the silicon sensor 350. The processor 360 (or other device) may change the performance of the processor 360 based on the received power information. The processor 360 may change (or adjust) a performance parameter based on the total system power information that is received (or the total system current). In other words, the processor 360 may receive total system power information.

The electronic device may be any one of a mobile terminal, a mobile device, a mobile computing platform, a mobile platform, a laptop computer, a tablet, an ultra-mobile personal computer, a mobile Internet device, a smartphone, a personal digital assistant, a display device, a television (TV), etc.

The following examples pertain to further embodiments

Example 1 is an electronic device comprising: a power monitor to receive system power to be delivered to a processor and to one or more components of a system, the power monitor to provide information corresponding to the system power, and a processor to change a performance of the processor based at least in part on the information corresponding to the system power.

In Example 3, the subject matter of Example 1 can optionally include that at least a portion of the information corresponding to the system power comprises an analog value, and the electronic device comprises a converting device to digitize the analog value.

In Example 4, the subject matter of Example 1 and Example 3 can optionally include a bus coupled to the converting device and to the processor to provide the digitized analog value to the processor.

In Example 5, the subject matter of Example 1 can optionally include that the power monitor includes a silicon sensor to provide at least a portion of the information corresponding to the system power.

In Example 6, the subject matter of Example 1 can optionally include that the power monitor includes a silicon sensor and the electronic device comprises a bus coupled to the silicon sensor and to the processor to provide at least a portion of the information corresponding to the system power to the processor.

In Example 7, the subject matter of Example 1 can optionally include that the information corresponding to the system power is to include a value corresponding to instantaneous power.

Example 8 is a method comprising: receiving system power to be delivered to a processor and to one or more components of a system, providing information corresponding to the system power, and changing a performance of the processor based at least in part on the information corresponding to the system power.

In Example 9, the subject matter of Example 8 can optionally include that providing information corresponding to the system power includes a battery charger providing at least a portion of the information corresponding to the system power.

In Example 10, the subject matter of Example 8 can optionally include that at least a portion of the information corresponding to the system power comprises an analog value, and the method comprises digitizing the analog value.

In Example 11, the subject matter of Example 8 and Example 10 can optionally include a providing the digitized analog value via a bus to the processor.

In Example 12, the subject matter of Example 8 can optionally include that providing information corresponding to the system power includes a silicon sensor providing at least a portion of the information corresponding to the system power.

In Example 13, the subject matter of Example 8 can optionally include that providing information corresponding to the system power includes providing at least a portion of the information corresponding to the system power from a silicon sensor to the processor via a bus.

In Example 14, the subject matter of Example 8 can optionally include that the information corresponding to the system power is to include a value corresponding to instantaneous power.

Example 15 is an electronic device comprising: first means for receiving system power to be delivered to a processor and to one or more components of a system and for providing information corresponding to the system power, and second means for changing a performance of the processor based at least in part on the information corresponding to the system power.

In Example 16, the subject matter of Example 15 can optionally include that the first means includes a battery charger to provide at least a portion of the information corresponding to the system power.

In Example 17, the subject matter of Example 15 can optionally include that at least a portion of the information corresponding to the system power comprises an analog value, and the electronic device comprises a converting device to digitize the analog value.

In Example 18, the subject matter of Example 15 and Example 17 can optionally include a bus coupled to the converting device and to the processor to provide the digitized analog value to the processor.

In Example 19, the subject matter of Example 15 can optionally include that the first means includes a silicon sensor to provide at least a portion of the information corresponding to the system power.

In Example 20, the subject matter of Example 15 can optionally include that the first means includes a silicon sensor and the electronic device comprises a bus coupled to the silicon sensor and to the processor to provide at least a portion of the information corresponding to the system power to the processor.

In Example 21, the subject matter of Example 15 can optionally include that the information corresponding to the system power is to include a value corresponding to instantaneous power.

Example 22 is a machine-readable medium comprising one or more instructions that when executed cause a processor to perform one or more operations to: receive information corresponding to system power that is to be delivered to a processor and to one or more components of a system, and changing a performance of the processor based at least in part on the information corresponding to the system power.

In Example 23, the subject matter of Example 22 can optionally include that the information corresponding to the system power corresponds to information to be provided by a power monitor.

In Example 24, the subject matter of Example 22 and Example 23 can optionally include that the power monitor includes a battery charger.

In Example 25, the subject matter of Example 22 and Example 23 can optionally include that the power monitor includes a silicon sensor.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electronic device comprising:
a power monitor to receive system power to be delivered to a processor and to one or more components of a system, the power monitor to provide information corresponding to the system power; and
a processor to change a performance of the processor based at least in part on the information corresponding to the system power.

2. The electronic device of claim 1, wherein the power monitor includes a battery charger to provide at least a portion of the information corresponding to the system power.

3. The electronic device of claim 1, wherein at least a portion of the information corresponding to the system power comprises an analog value, and the electronic device comprises a converting device to digitize the analog value.

4. The electronic device of claim 3, comprising a bus coupled to the converting device and to the processor to provide the digitized analog value to the processor.

5. The electronic device of claim 1, wherein the power monitor includes a silicon sensor to provide at least a portion of the information corresponding to the system power.

6. The electronic device of claim 1, wherein the power monitor includes a silicon sensor and the electronic device comprises a bus coupled to the silicon sensor and to the processor to provide at least a portion of the information corresponding to the system power to the processor.

7. The electronic device of claim 1, wherein the information corresponding to the system power is to include a value corresponding to instantaneous power.

8. A method comprising:
receiving system power to be delivered to a processor and to one or more components of a system;
providing information corresponding to the system power; and
changing a performance of the processor based at least in part on the information corresponding to the system power.

9. The method of claim 8, wherein providing information corresponding to the system power includes a battery charger providing at least a portion of the information corresponding to the system power.

10. The method of claim 8, wherein at least a portion of the information corresponding to the system power comprises an analog value, and the method comprises digitizing the analog value.

11. The method of claim 10, comprising a providing the digitized analog value via a bus to the processor.

12. The method of claim 8, wherein providing information corresponding to the system power includes a silicon sensor providing at least a portion of the information corresponding to the system power.

12. The method of claim 8, wherein providing information corresponding to the system power includes providing at least a portion of the information corresponding to the system power from a silicon sensor to the processor via a bus.

14. The method of claim 8, wherein the information corresponding to the system power is to include a value corresponding to instantaneous power.

15. An electronic device comprising:
first means for receiving system power to be delivered to a processor and to one or more components of a system and for providing information corresponding to the system power; and
second means for changing a performance of the processor based at least in part on the information corresponding to the system power.

16. The electronic device of claim 15, wherein the first means includes a battery charger to provide at least a portion of the information corresponding to the system power.

17. The electronic device of claim 15, wherein at least a portion of the information corresponding to the system power comprises an analog value, and the electronic device comprises a converting device to digitize the analog value.

18. The electronic device of claim 17, comprising a bus coupled to the converting device and to the processor to provide the digitized analog value to the processor.

19. The electronic device of claim 15, wherein the first means includes a silicon sensor to provide at least a portion of the information corresponding to the system power.

20. The electronic device of claim 15, wherein the first means includes a silicon sensor and the electronic device comprises a bus coupled to the silicon sensor and to the processor to provide at least a portion of the information corresponding to the system power to the processor.

21. The electronic device of claim 15, wherein the information corresponding to the system power is to include a value corresponding to instantaneous power.

22. A machine-readable medium comprising one or more instructions that when executed cause a processor to perform one or more operations to:
receive information corresponding to system power that is to be delivered to a processor and to one or more components of a system; and
changing a performance of the processor based at least in part on the information corresponding to the system power.

23. The machine-readable medium of claim 22, wherein the information corresponding to the system power corresponds to information to be provided by a power monitor.

24. The machine-readable medium of claim 23, wherein the power monitor includes a battery charger.

25. The machine-readable medium of claim 23, wherein the power monitor includes a silicon sensor.
